(19) United States
(12) Patent Application Publication
(10) Pub. No.: US 2004/0083859 A1
(43) Pub. Date: May 6, 2004

(54) High twisting ratchet wrench

(76) Inventor: Tsung-Chieh Chang, Taipei (TW)

Correspondence Address: Tsung-Chieh Chang, 235 Chung-Ho, Box 8-24, Taipei, TW

(21) Appl. No.: 10/284,527

(22) Filed: Nov. 1, 2002

(51) Int. Cl. B25B 13/46

(52) U.S. Cl. 81/63.1

(57) ABSTRACT

A high twisting ratchet wrench comprises a wrench body, a ratchet body, an adjusting means; two brake blocks, and two elastomers. The ratchet body, brake blocks and elastomers are installed in a head at one end of the wrench body. Each brake block is installed within one of two actuating grooves in inner edges of the head. An outer peripheral surface of each brake block has a plurality of buckling teeth. The head of the wrench body has two actuating grooves for receiving the brake blocks. Each actuating groove has a rectangular shape. A cross sectional view of each brake block has a rectangular shape. Thus, the area of the buckling teeth is increased so as to increase a contact area of the brake blocks and the ratchet body and thus the twisting force of the wrench body applied to an object locating within the ratchet body is enhanced.

### FIELD OF THE INVENTION

The present invention relates to wrenches, and particularly to a high twisting ratchet wrench which can provide enhanced twisting forces.

### BACKGROUND OF THE INVENTION

Referring to FIG. 6, a prior art ratchet wrench body is illustrated. A ratchet wrench has a wrench body, a ratchet body, a brake rod, steel balls, and elastomers. The ratchet body and the brake rod (or brake block) are installed in a head portion of the wrench body. By the engagement of buckling teeth on the brake rod and the ratchet body, the wrench has the functions of braking and engagement so as to move a screw element. With reference to FIG. 7, a plurality of buckling teeth are formed only at two ends of one side of the brake rod and thus only finite area to contact the ratchet body so that the twisting force of the ratchet body applied to the screw element in the ratchet body is confined. As a consequence, the operation of the wrench is limited.

### SUMMARY OF THE INVENTION

Accordingly, the primary object of the present invention is to provide a high twisting ratchet wrench which comprises a wrench body, a ratchet body, an adjusting means; two brake blocks, and two elastomers. The ratchet body, brake blocks and elastomers are installed in a head at one end of the wrench body. Each brake block is installed within one of two actuating groove in inner edges of the head. An outer peripheral surface of each brake block has a plurality of buckling teeth. The head of the wrench body has two actuating grooves for receiving the brake blocks. Each actuating groove has a rectangular shape. A cross sectional view of each brake block has a rectangular shape. Thus, the area of the buckling teeth is increased so as to increase a contact area of the brake blocks and the ratchet body and thus the twisting force of the wrench body applied to an object locating within the ratchet body is enhanced.

Moreover, in the present invention, there may be only one brake block is used in the wrench body.

The various objects and advantages of the present invention will be more readily understood from the following detailed description when read in conjunction with the appended drawing.

### BRIEF DESCRIPTION OF THE DRAWINGS

FIG. 1 is an exploded schematic view of the present invention.

FIG. 2 is an assembled cross sectional view of the present invention.

FIG. 3 is a schematic perspective view showing the brake blocks of the present invention.

FIG. 4 shows one embodiment about the brake blocks of the present invention.

FIG. 5 is an exploded schematic view of the second embodiment of the present invention.

FIG. 6 is an exploded schematic view of a prior art.

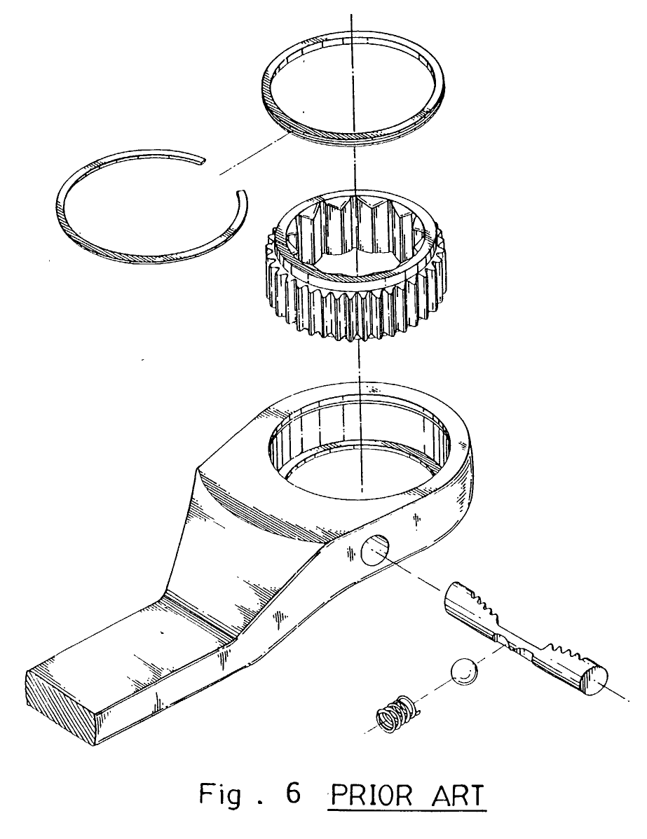

FIG. 7 is a schematic perspective view of a brake rod of the prior art.

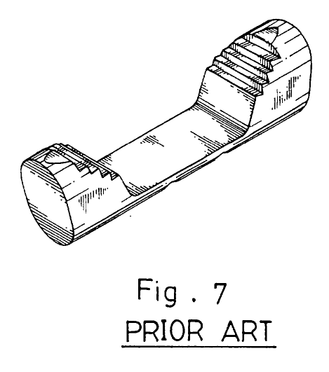

### DETAILED DESCRIPTION OF THE PREFERRED EMBODIMENTS

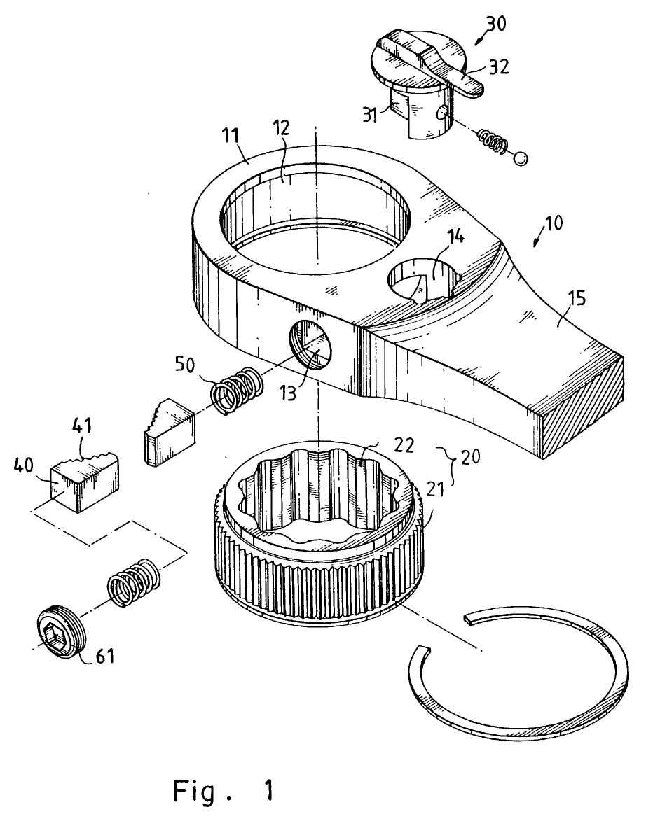

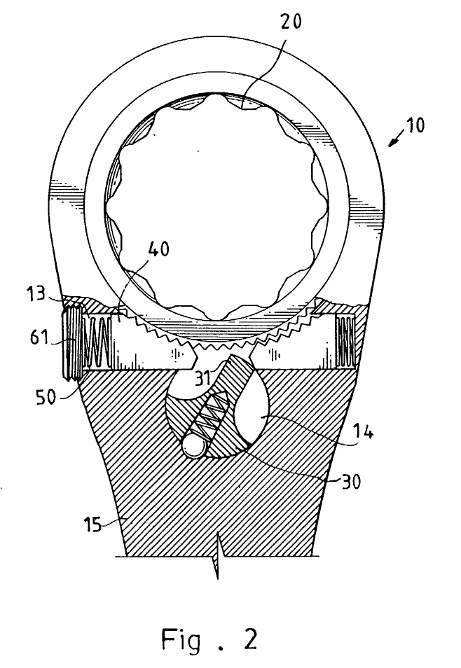

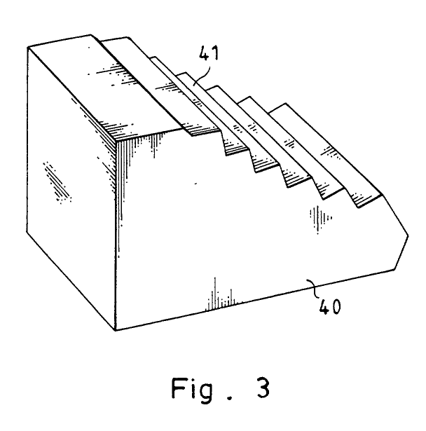

Referring to FIGS. 1 to 3, the high twisting ratchet wrench of the present invention is illustrated. The high twisting ratchet wrench of the present invention has a wrench body 10, a ratchet body 20, an adjuster means 30, two brake blocks 40, two elastomers 50, etc.

One end of the wrench body 10 has a head 11. The head 11 is formed with a receiving portion 12 and a brake groove 13 which are communicated with one another. The receiving portion 12 is installed with a ratchet wheel 20. The brake groove 13 is installed with the brake blocks 40. The brake groove 13 has a rectangular shape and is communicated with an actuating groove 14. The actuating groove 14 is formed at the connection of the head 11 and handle 15 of the wrench body 10 for receiving an adjusting means 30.

The ratchet body 20 is an annular teeth wheel. An outer periphery thereof is formed with ratchet teeth 21, and an inner edge thereof is formed with a clamping seat 22 for being engaged with a screw nut.

The adjusting means 30 is similar to a hat and a lower edge thereof has a moving portion 31 which is exactly received in the actuating groove 14. A front end of the adjusting means 30 is placed between the two brake blocks 40. The actuating rod 32 at a top of the adjusting means 30 serves to control the direction of the moving portion 31.

The two brake blocks 40 have rectangular shapes for being receiving within the brake groove 13. Each brake block 40 has an periphery surface with respect to the wrench body 10 and the periphery surface is formed with tapered buckling teeth 41.

Each outer side of the brake block 40 resists against with an elastomer 50. The elastomer 50 provides a resilient force to the brake block 40 and one side of the elastomer 50 is screwed tightly by a nut 61.

By above components, the buckling teeth 41 are installed along the outer peripheral surfaces of the brake blocks 40. Thereby, the areas of the teeth are increased. As shown in the figures, when the brake blocks 40 are engaged with the ratchet body 20, the buckling teeth 41 have a larger contact area to engage the ratchet teeth 21. Therefore, the ratchet wrench can achieve a maximum twisting force and a better strength.

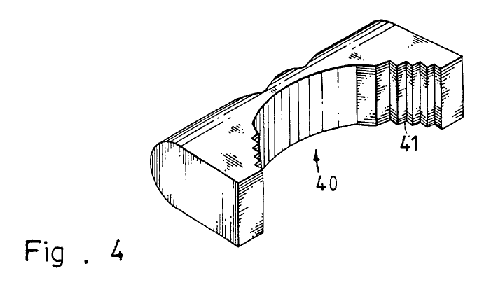

Moreover, referring to FIG. 4, in the present invention, the cross section of the combination of the brakes block 40 has a U shape cross section. That is, each brake block 40 has a cambered outer surface and a rectangular outer surface. The buckling teeth 41 are formed on the surface of the cambered surface of the brake block 40.

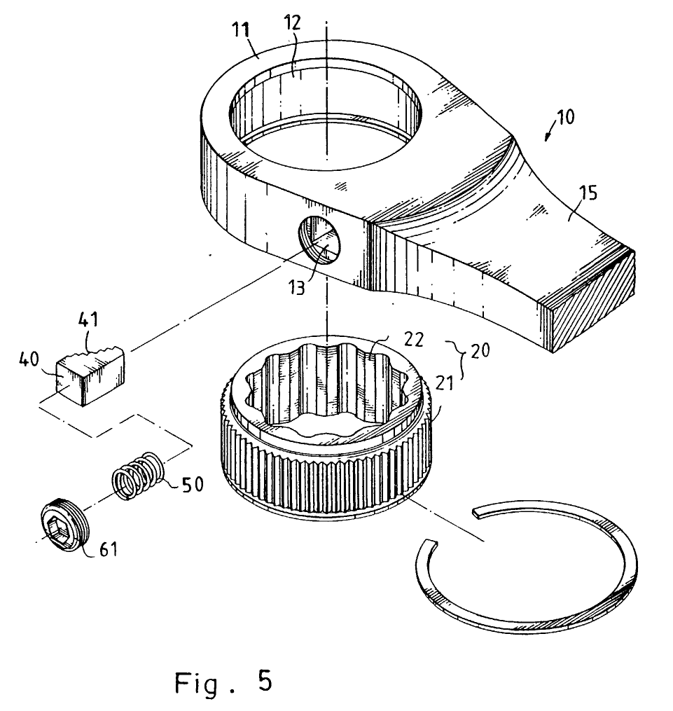

Referring to FIG. 5, in the present invention, it is possible that only one brake block 40 and one elastomer 50 are installed in the wrench body 10 so as to form a wrench which brakes at only one direction. Thereby, the adjusting means 30 is unnecessary to be installed.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A high twisting ratchet wrench comprising a wrench body, a ratchet body, an adjusting means; two brake blocks, and two elastomers; the ratchet body, brake blocks and elastomers being installed in a head at one end of the wrench body; each brake block being installed within one of two actuating grooves in inner edges of the head; characterized in that:
an outer peripheral surface of each brake block facing toward the ratchet body has a plurality of buckling teeth; the head of the wrench body has two actuating grooves for receiving the brake blocks; each actuating groove has a rectangular shape; a cross sectional view of each brake block has a rectangular shape; thus, an area of the buckling teeth is increased so as to increase a contact area of the brake blocks and the ratchet body and thus the twisting force of the wrench body applied to an object locating within the ratchet body is enhanced.

2. The high twisting ratchet wrench as claimed in claim 1, wherein a surface of the brake block at an opposite side having the buckling teeth has a rectangular shape.

3. A high twisting ratchet wrench comprising a wrench body, a ratchet body, an adjusting means; a brake block, and an elastomer; the ratchet body, brake block and elastomer are installed in a head at one end of the wrench body; the brake block is installed within an actuating groove in one inner edge of the head; characterized in that:
an outer peripheral surface of the brake block facing toward the ratchet body has a plurality of buckling teeth; the head of the wrench body has an actuating groove for receiving the brake block; the actuating groove has a rectangular shape; a cross sectional view of the brake block has a rectangular shape; thus, the area of the buckling teeth is increased so as to increase a contact area of the brake block and the ratchet body and thus the twisting force of the wrench body applied to an object locating within the ratchet body is enhanced.
